(19) United States
(12) Patent Application Publication
(10) Pub. No.: US 2025/0296034 A1
(43) Pub. Date: Sep. 25, 2025

(54) ENERGY EFFICIENT CATALYTIC REGENERATION OF AMINO-BASED CARBON DIOXIDE SORBENTS

(71) Applicant: UT-Battelle, LLC, Oak Ridge, TN (US)

(72) Inventors: Dhruba Deka, West Richland, WA (US); Gyoung Gug Jang, Knoxville, TN (US); Constantinos Tsouris, Oak Ridge, TN (US); Radu Custelcean, Knoxville, TN (US); Diana Stamberga, Lenoir City, TN (US)

(21) Appl. No.: 19/087,701

(22) Filed: Mar. 24, 2025

Related U.S. Application Data
(60) Provisional application No. 63/569,353, filed on Mar. 25, 2024.

(51) Int. Cl. B01D 53/14; B01J 21/06

(52) U.S. Cl. CPC B01D 53/1425; B01D 53/1475; B01D 53/1493; B01J 21/063; B01D 2252/20478; B01D 2252/20494; B01D 2257/504

(57) ABSTRACT

A method for regenerating an amine-containing sorbent useful in the capture of carbon dioxide (CO₂), by contacting a CO₂ complex of the amine-containing sorbent in solution with a metal oxide material while the solution is at a temperature within a range of 60-130° C. to result in release of CO₂ and regeneration of the amine-containing sorbent, wherein the CO₂ in the CO₂ complex is in the form of a carbamate or bicarbonate moiety attached to the amine-containing sorbent. The method may also include re-using the regenerated sorbent to capture carbon dioxide. The sorbent may be, for example, an amino acid (e.g., glycine), alkylamine, alkanolamine, or amine biphasic solvent. The metal oxide material may more particularly be selected from the group consisting of TiO₂, TiO(OH)₂, MoO₃, V₂O₅, Cr₂O₃, WO₃, Ag₂O, Nb₂O₅, NiO, CuO, MnO₂, ZrO₂, Fe₂O₃, Fe₃O₄, ZnO, and combinations thereof.

### CROSS-REFERENCE TO RELATED APPLICATIONS

The present application claims benefit of U.S. Provisional Application No. 63/569,353 filed Mar. 25, 2024, all of the contents of which are incorporated herein by reference.

### STATEMENT REGARDING FEDERALLY SPONSORED RESEARCH

This invention was made with government support under Prime Contract No. DE-AC05-00OR22725 awarded by the U.S. Department of Energy. The government has certain rights in the invention.

### FIELD OF THE INVENTION

The present invention generally relates to methods for regenerating carbon dioxide sorbent materials with simultaneous release and storage or usage of the captured carbon dioxide. The invention is particularly directed to the catalytic regeneration of sorbent materials, such as those based on amino acids, alkylamines, alkanolamines, amine biphasic solvents, and bis(iminoguanidine)s.

### BACKGROUND

Post-industrial revolution anthropogenic activities have led to a rapid rise in greenhouse gases, particularly carbon dioxide (CO₂). Direct air capture (DAC) and point source capture of CO₂ are increasingly being used as part of an effort to restore the atmospheric CO₂ concentration to an optimal level while mitigating climate change. Despite the technological maturity of the CO₂ absorption process, it is still far off from worldwide commercial deployment mainly due to the energy intensive nature of the solvent regeneration step, which is known to consume up to 70% of the total operating cost.

The high regeneration energy of amine-based solvents, such as monoethanolamine (MEA), stems from the stable nature of the carbamate and bicarbonate ions formed during CO₂ absorption. To break down such molecules and release the captured CO₂, three different forms of heat need to be supplied to the solvent: sensible heat (ΔHₛₑₙ) required to raise the solvent temperature to that of the reboiler, heat of vaporization (ΔHᵥₐₚ) needed to produce the stripping steam in the reboiler, and heat of CO₂-desorption (ΔH_{des}) needed to decompose carbamates and bicarbonates. The total regeneration energy is, therefore, given as: ΔHₜₒₜₐₗ=ΔHₛₑₙ+ΔHᵥₐₚ+ΔH_{des}. Among these heat terms, ΔH_{des} relates to bond energy in carbamate molecules and bicarbonates, and hence, cannot be changed for a particular solvent. On the other hand, ΔHₛₑₙ and ΔHᵥₐₚ are functions of the regeneration process and operating variables and which can be reduced by process modification. In a conventional regeneration process, a high reboiler temperature (for example, 120-140° C. for 30% aqueous amine solvent, i.e., 5M MEA) leads to high ΔHₛₑₙ and ΔHᵥₐₚ, and hence a high ΔHₜₒₜₐₗ. It is known that more than half of the supplied energy goes into sensible and vaporization heat in such scenarios (F. Vega et al., Applied Energy, 260 (2020) 114313).

More efficient regeneration is needed to permit solvent reuse and sustain stable CO₂ capture performance over time. Current research efforts have been mainly focused on developing low-energy-regeneration solvents and sorbents and their potential use in traditional temperature-swing processes. Although conductive heating systems are well-matured for large scale implementation, conventional solvent regeneration by conductive heating is often inefficient, especially for traditional aqueous solvents (e.g., 30 wt % monoethanolamine (MEA)), due to non-uniform heating and overheating, which also leads to solvent degradation. In general, CO₂ desorption from aqueous solvents occurs with diluent evaporation, resulting in a high energy penalty. Thus, there would be a significant benefit in a method that could regenerate CO₂ sorbents in a more energy efficient manner.

### SUMMARY

The present disclosure is foremost directed to a method for regenerating a carbon dioxide (CO₂) sorbent material by a more energy efficient process than conventional processes used in the art. The method is advantageously straightforward and can be practiced at very moderate temperatures, even at temperatures below 100° C. By virtue of the lower temperature requirement, the method also substantially avoids diluent evaporation, which makes the process even more efficient. A further advantage of the method is its reliance on low cost metal oxide catalysts, such as TiO₂.

The method more specifically entails contacting a CO₂ complex of the amine-containing sorbent in solution with a metal oxide material while the solution has a temperature within a range of 60-130° C. to result in release of CO₂ and regeneration of the amine-containing sorbent, wherein the CO₂ in the CO₂ complex is in the form of a carbamate or bicarbonate moiety attached to the amine-containing sorbent, and wherein the metal oxide material is a transition metal oxide or main group metal oxide material. The regenerated carbon dioxide sorbent material can then be re-used to capture (absorb) additional CO₂ to form additional sorbent-CO₂ complex, which can then be subjected to the above regeneration method to continue the cycle of CO₂ absorption followed by CO₂ release and regeneration of CO₂ sorbent material. The released CO₂ can be subsequently placed in storage or used in a process.

In some embodiments, the sorbent-CO₂ complex is a solid (e.g., crystalline or non-crystalline) complex with the capacity to be dissolved in an aqueous-based solvent or solution. In other embodiments, the sorbent-CO₂ complex is a solution of the complex. In some embodiments, the carbon dioxide sorbent material is an amine-containing sorbent, or more particularly, an amino acid, alkylamine, alkanolamine, amine biphasic solvent, or bis(iminoguanidinium) sorbent material. In some embodiments, the catalyst is or includes a transition metal oxide, such as one or more selected from TiO₂, TiO(OH)₂, MoO₃, V₂O₅, Cr₂O₃, WO₃, Ag₂O, Nb₂O₅, NiO, CuO, MnO₂, ZrO₂, Fe₂O₃, Fe₃O₄, ZnO, and combinations thereof. In other embodiments, the catalyst is a main group metal oxide, such as Al₂O₃ or an aluminosilicate.

### BRIEF DESCRIPTION OF THE DRAWINGS

FIG. 1. Drawings showing various forms of sarcosine in aqueous solution: (1) acidic state, (2) zwitterion state, and (3) deprotonated anionic state of sarcosine with potassium counter-ions.

FIG. 2. Schematic showing structures of Bronsted and Lewis acid sites on the TiO₂ surface in water as the surrounding environment.

FIG. 3. Depiction of the catalyst-assisted solvent regeneration experimental set-up consisting of a heating plate, magnetic stirring, condenser, thermocouples, and an infrared radiation-based CO₂ sensor.

FIGS. 4a-4b. Graphs showing rate of CO₂ desorption from CO₂-loaded K-Sar solvent in the absence of TiO₂ catalyst during a temperature rise from 25° C. to 95° C., followed by a steady temperature at 95° C. FIG. 4a shows the entire temperature range while FIG. 4b shows only the temperature ramp section. The primary y-axis represents CO₂ desorption rate, while the secondary y-axis represents temperature.

FIGS. 5a-5b. Graphs showing rate of CO₂ desorption from CO₂-loaded K-Sar solvent during a temperature-rise from 25° C. to 95° C., followed by a steady temperature at 95° C., in the absence of TiO₂ or the presence of 0.50 g TiO₂ (L/S=220). FIG. 5a shows the entire temperature range while FIG. 5b shows only the temperature ramp section. The primary y-axis represents CO₂ desorption rate while the secondary y-axis represents temperature. L/S stands for the weight ratio of liquid solvent to TiO₂ solid used during experiments.

FIG. 6. A schematic depiction of proposed CO₂-rich K-Sar regeneration pathways facilitated by the Lewis and Bronsted acid sites (LAS and BAS) present on TiO₂ surface.

FIGS. 7a-7b. Graphs showing rate of CO₂ desorption from CO₂-loaded K-Sar solvent during a temperature rise from 25° C. to 95° C., followed by a steady temperature of 95° C., in the presence of varied amount of TiO₂: 0 g, 0.25 g (L/S=440), 0.5 g (L/S=220) and 1.0 g (L/S=110). FIG. 7a shows the entire temperature range while FIG. 7b shows only the temperature ramp section. The primary y-axis represents CO₂ desorption rate, while the secondary y-axis represents temperature. L/S stands for the weight ratio of liquid solvent to TiO₂ solid used during experiments.

FIG. 8: Graph showing effect of L/S ratio on absorption and desorption rates of CO₂. The bars (primary y-axis) represent concentration of CO₂ in K-Sar solvent under various scenarios: Initial loading (uptake of CO₂ during absorption experiment), regeneration without any TiO₂, and regeneration with various TiO₂ amounts (L/S=440, L/S=220, L/S=110). L/S stands for the weight ratio of liquid solvent to TiO₂ solid used during experiments. Diamond shaped symbols (secondary y-axis) represent percentage of CO₂ removed from the CO₂-loaded solvent.

FIG. 9. Graph showing CO₂ absorption as a function of time with no TiO₂ and with 0.25 g TiO₂ (L/S=440). Y-axis represents concentration of CO₂ in the solvent vs. time during absorption test. Measurements were repeatable within 1% error.

FIG. 10. Graph showing effect of L/S ratio on regeneration energy. The bars (primary y-axis) represent K-Sar solvent regeneration energies under various scenarios: regeneration with no TiO₂, and regeneration with various TiO₂ amounts (L/S=440, L/S=220, L/S=110). Assuming the regeneration energy for the no-catalyst case as a reference, the percentage decrease in regeneration energy compared to this reference value was calculated and plotted as diamond symbols (secondary y-axis).

FIGS. 11a-11b. FIG. 11a is a graph showing rate of CO₂ desorption from CO₂-loaded K-Sar solvent during a temperature rise from 25° C. to 95° C. or 100° C. and followed by a steady temperature of 95° C. or 100° C., in the presence of 0.50 g of TiO₂ (L/S=220). The primary y-axis represents CO₂ desorption rate, while the secondary y-axis represents solvent temperature. FIG. 11b is a graph showing percentage of CO₂ removed from CO₂-loaded K-Sar when the solvent is heated to two different temperatures, 95° C. and 100° C.

FIG. 12. X-ray diffraction patterns of TiO₂ powder before and after being used in K-Sar regeneration. Scanning electron microscopy images of the two samples are also shown in the inset images.

FIG. 13. ¹H NMR spectra of 3M K-Sar solvent in fresh, CO₂-loaded, and regenerated in presence of TiO₂ conditions.

### DETAILED DESCRIPTION

The amine-containing sorbent (i.e., “sorbent”) can be any of those materials known in the art that contain at least one amino or imino group and absorb (capture) the carbon dioxide in the form of carbamate, bicarbonate, or carbonate. Amine-containing sorbent materials are well known in the art. The resulting sorbent-CO₂ complex may be a solid or liquid with the capacity to be dissolved in an aqueous-based solvent or solution.

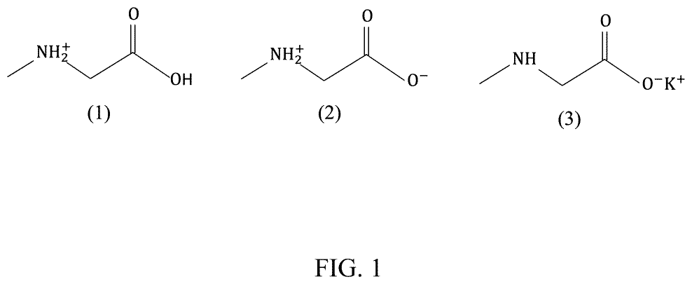

In one set of embodiments, the amine-containing sorbent is or includes an amino acid. The amino acid may be in its uncharged form, acidic (cationic) form, zwitterionic form, or deprotonated anionic salt form. Any amino acid, including natural and non-natural amino acids, can function as a carbon dioxide sorbent, although some amino acids may function better than others. The amino acid may be an alpha- or beta-amino acid, or a derivative or mimic of an amino acid (e.g., taurine). Some examples of suitable amino acids include sarcosine, glycine, alanine, beta-alanine (3-aminopropanoic acid), valine, leucine, isoleucine, serine, threonine, glutamine, asparagine, glutamic acid, aspartic acid, lysine, histidine, arginine, phenylalanine, tyrosine, proline, and tryptophan, and N-alkyl derivatives, ester derivatives, or salts of any of the foregoing amino acids. In some embodiments, the amino acid is selected from glycine and/or N-alkylglycines, wherein the alkyl group is independently selected from hydrocarbon groups containing 1-6 carbon atoms (e.g., methyl, ethyl, n-propyl, isopropyl, n-butyl, isobutyl, sec-butyl, t-butyl, n-pentyl, isopentyl, n-hexyl, and isohexyl). Some examples of N-alkylglycines include sarcosine (where the N-alkyl group is methyl) and N-methylalanine. In particular embodiments, the amino acid is or include sarcosine, which may be in its neutral form, acidic (cationic) form, zwitterionic form, or deprotonated anionic salt form (sarcosinate). The acidic (cationic), zwitterionic, and deprotonated anionic salt forms of sarcosine are shown in FIG. 1.

In other embodiments, the amine-containing sorbent is an alkylamine. The alkylamine may, in some embodiments, be a hydrophobic amine that can dissolve in an organic (non-aqueous) solvent (NAS) or low-aqueous solvent (LAS). In other embodiments, the alkylamine can dissolve in an aqueous solution. The alkylamine typically has the formula NR^{d}R^{e}R^{f}, wherein R^{d}, R^{e}, and R^{f} are selected from H and hydrocarbon groups containing one or more carbon atoms, wherein one, two, or all three of R^{d}, R^{e}, and R^{f} are selected from hydrocarbon groups. The hydrocarbon groups may independently contain 1, 2, 3, 4, 5, 6, 7, 8, 9, 10, 11, or 12 carbon atoms and may or may not contain one or more heteroatoms selected from O, N, and S. In different embodiments, the hydrocarbon groups contain 1-12, 1-6, 1-4, 1-3, 2-12, 2-6, 2-4, or 2-3 carbon atoms. The hydrocarbon groups may be linear or branched alkyl or alkenyl groups or saturated or unsaturated monocyclic or bicyclic groups. Some examples of hydrocarbon groups include methyl, ethyl, n-propyl, isopropyl, n-butyl, isobutyl, n-pentyl, n-hexyl, isohexyl, n-octyl, 2-ethylhexyl, 2-ethyloctyl, n-decyl, n-dodecyl, cyclohexyl, phenyl, pyridyl, and tolyl groups.

In other embodiments, the amine-containing sorbent is an alkanolamine. Alkanolamines are well known in the art for carbon dioxide capture. Some examples of alkanolamines include monoethanolamine (MEA), diethanolamine (DEA), triethanolamine (TEA), diglycolamine (DGA), methyldiethanolamine (MDEA), diisopropanolamine, 2-amino-2-methyl-1-propanol, 2-(piperidin-2-yl) ethanol, 2-(diethylamino) ethanol (DEEA), N-butyldiethanolamine (BDEA), N-t-butyldiethanolamine (t-BDEA), and N-ethyldiethanolamine (EDEA).

In yet other embodiments, the amine-containing sorbent is an amine biphasic solvent. As well known, biphasic solvents are composed of mixtures of multiple amine molecules which undergo phase separation into CO₂-rich and CO₂-lean phases when the absorbed CO₂ concentration exceeds a threshold. This allows only the rich phase to proceed to regeneration, thus reducing energy demand while maintaining CO₂ recovery efficiency. An exemplary formulation contains the following components: 1) diethylenetriamine (DETA) —primary absorbent (primary/secondary amine), 2) dimethylaminocthanol (DMAE) —adsorption/desorption facilitator (tertiary amine), 3) triethylene glycol dimethyl ether (TEG-DME) —phase change facilitator, and 4) water—base solvent ensuring a homogeneous phase when CO2 is unloaded. After regeneration, the two phases recombine into a single homogeneous phase. Other examples of biphasic solvent formulations include 1) triethylenetetramine (TETA)/2-(diethylamino) ethanol (DEEA)/H₂O, 2) TETA/DEEA/sulfolane, 3) N,N-dimethyl propylamine (DMPA)/poly(ethylene glycol) dimethyl ether (NHD)/H₂O, and 4) N,N-dimethylethanolamine (DMEA)/piperazine (PZ)/N-butanol (n-BuOH)/H₂O. Some references describing the various types of biphasic solvents include: 1) X. Zhou, et al., Environ. Sci. Technol. 2021, 55, 22, 15313-15322; 2) J. Ye, et al., Environ. Sci. Technol. 2019, 53, 8, 4470-4479; 3) L. Wang, et al., Environ. Sci. Technol. 2019, 53, 21, 12873-12881; 4) Z Chen, et al., Environ. Sci. Technol. 2022, 56, 18, 13305-13313; and 5) R. Wang, et al. Energy 2022, 260, 125045, the contents of which are herein incorporated by reference in their entirety.

In the present disclosure, the amine-containing sorbent, such as any of those described above, reacts with carbon dioxide to form a carbamate or an ion pair bond of the formula:

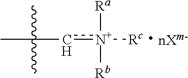

wherein R^{a}, R^{b}, and R^{c} are selected from H and hydrocarbon groups as described above, e.g., containing 1-12 carbon atoms (e.g., methyl and any of the other hydrocarbon groups described above), wherein at least one of R^{a}, R^{b}, and R^{c} is H; the dashed double bond represents the presence or absence of a double bond (i.e., if the dashed double bond is absent, the single bond to R^{c} remains), and the dashed single bond represents the presence or absence of R^{c}, wherein R^{c} is present only if the double bond is not present (or conversely, R^{c} is absent if the double bond is present); X^{m-} is a carbonate (CO₃²⁻) or bicarbonate (HCO₃⁻) anion, with m being 1 for bicarbonate and 2 for carbonate; and n is an integer of 1 or 2, provided that n×m=2.

More specifically, the ion pair bond has any of the following two formulas:

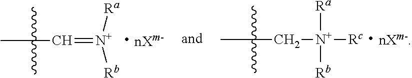

In the method for regenerating a carbon dioxide sorbent material, a sorbent-CO₂ complex containing CO₂ in the form of a carbamate, carbonate, or bicarbonate, as described above, is contacted with a metal oxide material in solution while the solution is at a temperature within a range of 60-130° C. In different embodiments, the solution is raised to a temperature of precisely or about, for example, 60, 70, 80, 90, 100, 110, 120, or 130° C., or the solution is raised to a temperature within a range bounded by any two of the foregoing values (e.g., 60-120° C., 60-110° C., 60-100° C., 60-90° C., 70-130° C., 70-120° C., 70-110° C., 70-100° C., 70-90° C., 80-130° C., 80-120° C., 80-110° C., 80-100° C., 90-130° C., 90-120° C., or 90-110° C.). Notably, the contacting step can be done by, for example, mixing a solution of the sorbent-CO₂ complex with a solution or suspension of the metal oxide, or adding a metal oxide (in solid or solution form) to a solution of the sorbent-CO₂ complex, or dissolving a solid sorbent-CO₂ complex in a solvent or solution followed by addition of a metal oxide to the solution (wherein the metal oxide can be added as a solution or in solid form), or adding a solution containing the sorbent-CO₂ complex to a solution or suspension containing the metal oxide. For any of the foregoing possibilities, the final made solution containing the sorbent-CO₂ complex and metal oxide is heated to any of the above temperatures or ranges thereof to result in regeneration of the sorbent. When regeneration is initiated at a suitable temperature, CO₂ is evolved simultaneously with the regeneration of the sorbent. The evolved CO₂ may be captured for long term storage or used in a CO₂-to-product conversion process (e.g., conversion to alcohol(s) or gasoline) by means well known in the art. Moreover, the regenerated carbon dioxide sorbent material can then be re-used to capture (absorb) additional CO₂ to form additional sorbent-CO₂ complex, which can then be subjected to the above regeneration method to continue the cycle of CO₂ absorption followed by CO₂ release and regeneration of CO₂ sorbent material. Prior to re-use of the sorbent, the metal oxide material may be separated from the sorbent or removed from the solution by, for example, filtration.

The contacting step may also include the possibility that the sorbent is in the presence of the metal oxide when the sorbent is contacted with CO₂ to produce the sorbent-CO₂ complex, i.e., the sorbent-CO₂ complex may be produced in situ in the presence of the metal oxide before the solution is sufficiently elevated in temperature to regenerate the sorbent and release the CO₂. For example, the contacting step may be practiced by producing a solution containing the sorbent and metal oxide, followed by contacting the solution with a gaseous source containing carbon dioxide to produce the sorbent-CO₂ complex in the presence of the metal oxide in the solution, before heating the solution to result in regeneration of the sorbent. The final solution in which the sorbent-CO₂ complex is contacted with (or in the presence of) the metal oxide typically contains an aqueous solvent. In one embodiment, the aqueous solvent contains only water. In other embodiments, the aqueous solvent contains water in admixture with a water-miscible organic solvent (e.g., an alcohol, acetone, acetonitrile, THF, or DMF).

The metal oxide is typically a transition metal oxide or main group metal oxide. The transition metal may be any of the elements in Groups 1-12 of the Periodic Table and may be a first row, second row, or third row transition metal. The main group metal may be any of the elements in Groups 13-15 of the Periodic Table. The metal oxide may or may not include hydroxide (OH) groups. Some examples of transition metal oxide compositions include Sc₂O₃, TiO₂ (titania), TiO(OH)₂, MoO₃, V₂O₅, Cr₂O₃, Fe₂O₃, Fe₃O₄, FeO, FeO(OH), Co₂O₃, Ni₂O₃, NiO, CuO, Cu₂O, MnO₂, ZnO, Y₂O₃ (yttria), ZrO₂ (zirconia), NbO₂, Nb₂O₅, RuO₂, PdO, Ag₂O, CdO, HfO₂, Ta₂O₅, WO₃, WO₂, Ag₂O, and PtO₂. Some examples of main group metal oxide compositions include SiO₂ (i.e., silica, e.g., glass or ceramic), B₂O₃, Al₂O₃ (alumina), Ga₂O₃, SnO, SnO₂, PbO, PbO₂, Sb₂O₃, Sb₂O₅, and Bi₂O₃. The metal oxide may also include one or more lanthanide metals. Some examples of lanthanide metal oxide compositions include La₂O₃, Ce₂O₃, and CeO₂. In particular embodiments, the metal oxide composition is selected from one or more of the following compositions: TiO₂, TiO(OH)₂, MoO₃, V₂O₅, Cr₂O₃, WO₃, Ag₂O, Nb₂O₅, NiO, CuO, MnO₂, ZrO₂, Fe₂O₃, Fe₃O₄, ZnO, and combinations thereof. In other particular embodiments, the metal oxide is or includes TiO₂, TiO(OH)₂, or a combination thereof. In other particular embodiments, the metal oxide is or includes Al₂O₃ (alumina) or silica (SiO₂). In other particular embodiments, the metal oxide is or includes a silicate or an aluminosilicate (i.e., zeolites). The zeolite may be an H-type zeolite or metal ion-exchanged zeolite. Some examples of zeolites include HZSM-5, H-Y, H-Beta, SAPO-34, MCM-41, and SSZ-13 types of zeolites. Any of the metal oxide materials described herein may or may not be adhered to a support, such as a carbon-containing support.

In some embodiments, the metal oxide has a perovskite structure of the formula:

M′M″O₃ (1)

In Formula (1) above, M′ and M″ are different metal cations, thereby being further exemplary of mixed-metal oxide compositions. The metal cations can be independently selected from, for example, the first, second, and third row transition metals, main group metals, and lanthanide metals. More typically, M′ represents a trivalent metal and M″ represents a transition metal, and more typically, a first row transition metal. Some examples of perovskite oxides include CaTiO₃, SrTiO₃, BaTiO₃, LaCrO₃, LaMnO₃, LaFeO₃, YCrO₃, LiNbO₃, and YMnO₃. In some embodiments, one or more (or all) perovskite compositions are excluded from the adhesive composition.

In other embodiments, the metal oxide has a spinel structure of the formula:

Mₓ′M″₃₋ₓO₄ (2)

In Formula (2) above, M′ and M″ are the same or different metal cations. Typically, at least one of M′ and M″ is a transition metal cation, and more typically, a first-row transition metal cation. In order to maintain charge neutrality with the four oxide atoms, the oxidation states of M′ and M″ sum to +8. Generally, two-thirds of the metal ions are in the +3 state while one-third of the metal ions are in the +2 state. The +3 metal ions generally occupy an equal number of tetrahedral and octahedral sites, whereas the +2 metal ions generally occupy half of the octahedral sites. However, Formula (2) includes other chemically-acceptable possibilities, including that the +3 metal ions or +2 metal ions occupy only octahedral or tetrahedral sites, or occupy one type of site more than another type of site. The subscript x can be any numerical (integral or non-integral) positive value, typically at least 0.01 and up to 1.5.

In some embodiments of Formula (2), the spinel structure has the composition:

M′M″₂O₄ (2a)

In Formula (2a) above, M″ is typically a trivalent metal ion and M′ is typically a divalent metal ion. More typically, M′ and M″ independently represent transition metals, and more typically, first row transition metals. Some examples of spinel compositions include NiCr₂O₄, CuCr₂O₄, ZnCr₂O₄, CdCr₂O₄, MnCr₂O₄, NiMn₂O₄, CuMn₂O₄, ZnMn₂O₄, CdMn₂O₄, NiCo₂O₄, CuCo₂O₄, ZnCo₂O₄, CdCo₂O₄, MnCo₂O₄, NiFc₂O₄, CuFe₂O₄, ZnFc₂O₄, CdFe₂O₄, and MnFc₂O₄. M′ and M″ can also be combinations of metals, such as in (Co,Zn)Cr₂O₄, and Ni(Cr, Fe)₂O₄. In some embodiments, one or more (or all) spinel compositions are excluded from the adhesive composition.

In some embodiments, the metal oxide material is in particulate form in the solution in which regeneration of the carbon dioxide sorbent occurs. In some embodiments, the metal oxide particles are macroscopic pellets, which have a size of, for example, 0.5-10 mm. In some embodiments, the pellets have a size of at least 1 mm and up to, for example, 2, 5, or 10 mm. In other embodiments, the metal oxide particles are in the micron size range, typically up to or less than 500 microns (0.5 mm). In different embodiments, the metal oxide particles have an average size or substantially uniform size of precisely or about, for example, 0.5, 0.6, 0.7, 0.8, 1, 2, 5, 10, 20, 50, 100, 200, 300, 400, or 500 microns, or an average size or substantially uniform size within a range bounded by any two of the foregoing values, e.g., 0.5-500 microns, 0.5-200 microns, 0.5-100 microns, 0.5-50 microns, 0.5-20 microns, 0.5-10 microns, 0.5-5 microns, 1-500 microns, 1-200 microns, 1-100 microns, 1-50 microns, 1-20 microns, 1-10 microns, or 1-5 microns, wherein the term “about” generally indicates no more than ±10%, ±5%, or ±1% from an indicated value. In other embodiments, the metal oxide particles are in the nanometer size range, typically up to or less than 500 nm. In different embodiments, the solid particles have an average size or substantially uniform size of precisely or about, for example, 1, 2, 5, 10, 20, 30, 40, 50, 100, 200, 300, 400, or 500 nm, or an average size or substantially uniform size within a range bounded by any two of the foregoing values, e.g., 1-500 nm, 1-200 nm, 1-100 nm, 1-50 nm, 1-20 nm, 1-10 nm, 2-500 nm, 2-200 nm, 2-100 nm, 2-50 nm, 2-20 nm, 2-10 nm, 5-500 nm, 5-200 nm, 5-100 nm, 5-50 nm, 5-20 nm, 5-10 nm, 10-500 nm, 10-200 nm, 10-100 nm, 10-50 nm, 10-20 nm, 20-500 nm, 20-200 nm, 20-100 nm, or 20-50 nm. In other embodiments, the metal oxide particles have an average size or substantially uniform size within a range spanning any two of the macroscopic, micron, or nanometer sizes provided above, e.g., 1 nm to 10 mm, or 1 nm to 1 micron (1000 nm), or 1 micron to 10 mm, or 1 micron to 1 mm, or 0.1 to 1 mm. In some embodiments, at least 80%, 85%, 90%, 95%, 98%, or 99% of the particles have a size within any range provided above. In some embodiments, 100% of the particles have a size within any of the ranges provided above. For particles in which the three dimensions are not the same (e.g., plate or fiber), the particle size may refer to the longest dimension or to an average of two or three dimensions of the particles.

Notably, at least the surface of the metal oxide particles have a metal oxide composition. In some embodiments, the entire volume of the metal oxide particles has a metal oxide composition. In other embodiments, the metal oxide particles have a core-shell structure containing a metal oxide shell on a non-metal oxide (e.g., carbon or elemental metal) core. The metal oxide particles may also have a core-shell arrangement containing both a metal oxide core and metal oxide shell, wherein the core and shell have different metal oxide compositions (e.g., TiO₂ shell on SiO₂ or Al₂O₃ core).

The metal oxide material may alternatively be in the form of a monolithic structure (i.e., “structured packing geometry”) constructed of bonded metal oxide particles and channels for heating or cooling liquid flow between the channels. The monolithic structure is typically macroscopic in size, typically at least 1 cm in at least one dimension. In some embodiments, the monolithic structure has a columnar or cuboidal shape. At least the surface of the particles in the monolithic structure have a metal oxide composition selected from transition metal oxide, main group metal oxide, and lanthanide oxide compositions, as described in detail above. The bonded particles in the monolithic structure may have any of the metal oxide compositions described above. Monolithic structures constructed of bonded metal oxide particles and having channels are well known in the art, such as described in U.S. Pat. No. 11,504,692, the contents of which are herein incorporated by reference. In some embodiments, the monolithic structure is produced by use of an additive manufacturing (e.g., 3D printing) method. In some embodiments, a monolithic structure constructed of elemental metal particles (e.g., Ti) is first produced followed by oxidation (e.g., by chemical or electrochemical means) to the corresponding metal oxide (e.g., TiO₂ and/or TiO(OH)₂). The resulting particles in the monolithic structure may then have a core-shell arrangement in which a metal oxide shell encapsulates an elemental metal core (e.g., TiO₂ on Ti).

In some embodiments, the method for regenerating a carbon dioxide sorbent, as described above, is integrated with a CO₂ production and capture process. In the CO₂ production and capture process, a gaseous source containing CO₂ is contacted with the CO₂ sorbent. Typically, the CO₂ is produced as an undesirable byproduct. The gaseous source can be, for example, air, waste gas from an industrial or commercial process, flue gas from a power plant, exhaust from an engine, or sewage or landfill gas. As discussed earlier above, the sorbent may be a liquid or a solid. Methods for capturing CO₂ from gaseous streams are well known in the art.

Examples have been set forth below for the purpose of illustration and to describe certain specific embodiments of the invention. However, the scope of this invention is not to be in any way limited by the examples set forth herein.

### EXAMPLES

### Overview

In the following experiments, an aqueous solution of potassium sarcosinate (K-Sar) was used as a CO₂ sorbent. As shown in FIG. 1, sarcosine, an amino acid, exists in three main states: (1) an acidic state, (2) a zwitterion state, and (3) a deprotonated anionic state. The first two of these states cannot absorb CO₂ on their own, hence a strong base such as KOH needs to be added to form a salt and increase the concentration of the anionic state of sarcosine (structure 3 in FIG. 1). This permits the secondary amine group to react with CO₂, thereby capturing it. Recent publications have reported on the CO₂ absorption kinetics and regeneration energy for K-Sar solvent implying at a larger absorption capacity than the widely used MEA solvent and comparable desorption energetics (U. E. Aronu et al., Industrial & Engineering Chemistry Research, 50 (2011) 10465-10475; A. Kasturi et al., Separation and Purification Technology, 310 (2023) 123154). It is known that more than 90% of the total regeneration energy of K-Sar comes in the forms of ΔHₛₑₙ and ΔHᵥₐₚ, and vast majority of this arises solely from ΔHᵥₐₚ. Therefore, a significant reduction in the total energy can be achieved if these two heat terms are decreased with a catalyst.

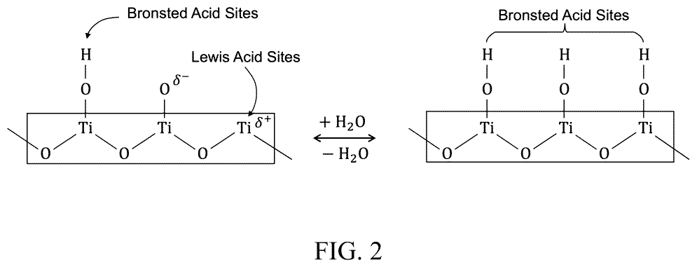

The following experiments employ TiO₂ as a catalyst in the regeneration of CO₂-loaded K-Sar solvent. As mentioned earlier, acidic sites on the solid catalyst surface play a vital role in accelerating the CO₂ desorption process. Both Bronsted and Lewis acid sites are available on TiO₂ surface under water environment. As shown in FIG. 2, the Lewis acid sites are a result of unsaturated Ti sites whereas interaction with water leads to the formation of Bronsted acid sites. These acidic sites on TiO₂ are known to be water tolerant. In addition to the abundance of acidic sites, TiO₂ is also hydrothermally stable because of the strong Ti—O—Ti bond; such stability is a necessary property for long-term usability in solvent regeneration applications. As known, the acidic nature and hydrothermal stability of TiO₂ can be further enhanced by adding other secondary metal oxide phases such as SiO₂. Titanium is also one of the few metals amenable to additive manufacturing processes (e.g., 3D printing) for fabrication of complex structured packing geometries, which allows process intensification for additional energy savings. The surface of packing materials made of titanium can be electrochemically converted to TiO₂, thereby making them usable for catalytic regeneration applications in large scale. For all these reasons, TiO₂ was selected as the model catalyst in this study. As explained below, TiO₂ showed a remarkable decrease of K-Sar regeneration energy, by almost 50%, when compared to the no catalyst case. X-ray diffraction, scanning electron microscopy, and nuclear magnetic resonance characterization results indicated a robust system where both the catalyst and the solvent remained structurally and chemically stable after solvent regeneration runs.

### Experimental Methods

An aqueous solution of 3M Potassium sarcosinate (K-Sar) was prepared by dissolving equimolar amounts of sarcosine and KOH in deionized water. The fresh K-Sar solvent prepared this way was then loaded with CO₂ by bubbling 100 mL/min of CO₂ flow through the solvent at room temperature. While CO₂-rich K-Sar feed stock for subsequent regeneration experiments was prepared in larger batches by passing CO₂ over IL of solvent, a few dedicated absorption experiments with smaller solvent volume were also carried out to evaluate CO₂ absorption kinetics. In these experiments, 100 mL fresh K-Sar was contained in a cylinder (cross-sectional area of ˜1.75 cm²) and 100 mL/min of pure CO₂ was sparged through the solvent. One mL of solvent sample was collected at fixed time intervals for CO₂ content analysis by total inorganic carbon measurement. The CO₂-loaded solvent was subsequently used for regeneration investigations in the presence or absence of TiO₂ catalyst (anatase phase, 99.7% pure on trace metals basis, ˜25 nm particle size).

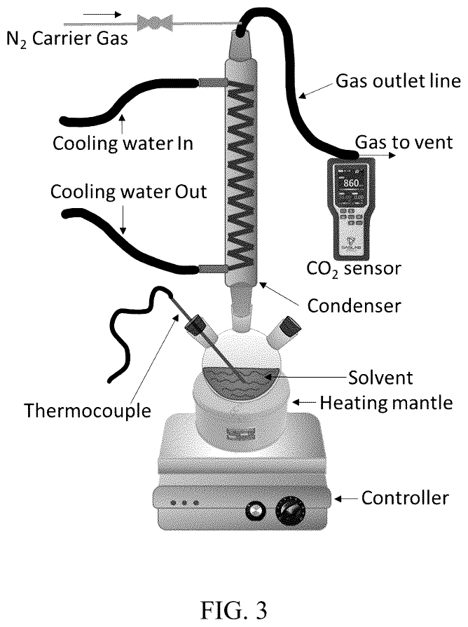

The regeneration experimental system used is shown in FIG. 3 and consists of a multi-neck flask to contain the solvent. One opening of the flask was used to insert two thermocouples into the liquid, one thermocouple to control the solvent temperature during heating, and the other to independently monitor the temperature. A magnetic heater-stirrer was used to heat the solvent. The center opening of the flask was connected to a condenser to condense out any water and solvent in the overhead gas space. The condensed water and solvent then trickled down the condenser back to the flask, thereby allowing only minimal loss of the solvent during regeneration experiments. The CO₂ desorbed from the solvent by heating escapes from the condenser outlet from where it is swept by a N2 carrier gas to an infra-red detection-based CO₂ sensor that measures desorbed CO₂ as a function of time. These sensors and thermocouples are connected to a computer system for automatic logging of real-time CO₂ concentration and temperature data. A constant electrical power (3.2 Watts) was supplied to the regeneration system; therefore, the total energy spent in an experiment during a fixed time interval could be directly estimated as: E=Power X time. The total regeneration energy then can be calculated as E/moles of desorbed CO₂.

X-ray diffraction (XRD) measurements were conducted using a commercial XRD system equipped with a solid-state detector. For the XRD measurements, X-rays were generated at 45 kV/40 mA, and the X-ray beam wavelength was λ=1.5406 Å (Cu Kα radiation). Scanning electron microscopy (SEM) and energy-dispersive X-ray spectroscopy (EDS) were carried out using a field emission scanning electron microanalyzer. Nuclear magnetic Resonance (NMR) measurements were performed to investigate potential solvent degradation after regeneration. 1D quantitative ¹H NMR spectra were recorded on a 400 MHz NMR spectrometer equipped with a 5 mm PABBI probe. A total Inorganic Carbon Analyzer consisting of an Acidification Module and Coulometer Module was used to determine inorganic carbon content in liquid samples. Air at 100 mL/min was used as the carrier gas, and calculations were based on the sample volume. 1 M Na₂CO₃ solution was used as a standard. For each sample, 200 μL of liquid was pipetted into a 15-mL sample flask, and a volume of 5 mL of 2 M HCl was added.

### Results and Discussion

1. Regeneration Dynamics without Catalyst

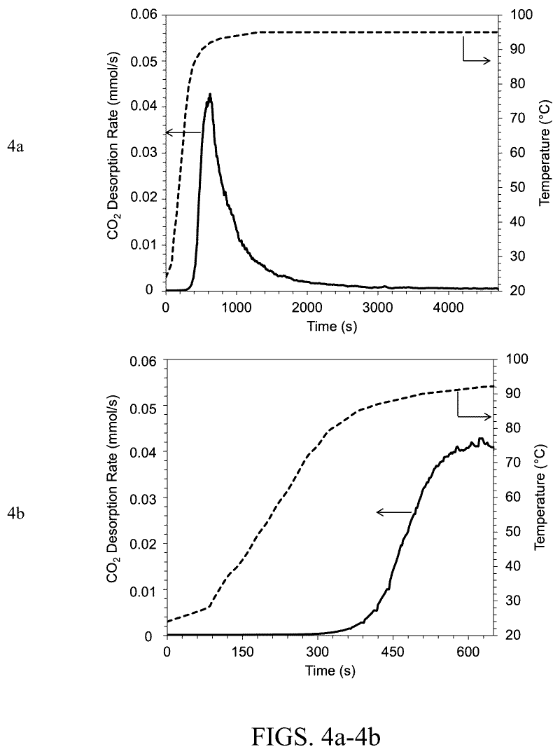

Regeneration of CO₂-rich solvent by conventional thermal treatment is a simple, widely used approach that can be implemented easily on industrial scale. A similar route for K-Sar regeneration is adopted for this study and a catalyst-assisted route was explored to improve energy efficiency. FIGS. 4a and 4b show the rate of CO₂ desorption from CO₂-rich K-Sar solvent during a temperature ramp from 25° C. to 95° C. in the absence of any catalyst. The CO₂ desorption rate is plotted along the primary y-axis while the solvent temperature is plotted along the secondary y-axis. As can be seen in FIG. 4a, the experiment includes two heating phases: first, a temperature ramp section up to 95° C. and second, an isothermal hold section. An enlarged scale plot with solely the ramp section is shown in FIG. 4b. One can easily observe that CO₂ desorption initiates at around 70° C. followed by a sharp rise in CO₂ in the exhaust gas. The desorption rate tapers off as the temperature ramp rate decreases and approaches the isothermal section. As evident from FIG. 4b, the highest CO₂ desorption rate of 0.042 mmol/s is achieved at 92° C., beyond which it drops continuously. Note that although the desorption rate decreases, evolution of CO₂ continues to occur throughout the isothermal phase.

To better explain the desorption profile, one must first understand the chemistry behind CO₂ absorption by K-Sar, which includes multiple chemical species with varied concentrations and thermodynamic stability. The major route of CO₂ absorption in K-Sar is the formation of a carbamate, KSarCOO⁻, as shown in Reaction 2 below. Such carbamate formation is accompanied by protonation of the second KSAR molecule acting as a base, leading to formation of KSarH⁺.

CO₂+2 KSar→KSarCOO⁻+KSarH⁺ (2)

Formation of a carbamate is thought to proceed via a zwitterion formation, as is known for the case of MEA. The zwitterion mechanism consists of two steps: in the first step, CO₂ and K-Sar molecules react to form a zwitterion (Reaction 3) which then undergoes deprotonation by a base in the second step (Reaction 4) to form a carbamate. The base, B, in this case could be either K-Sar, H₂O or OH⁻.

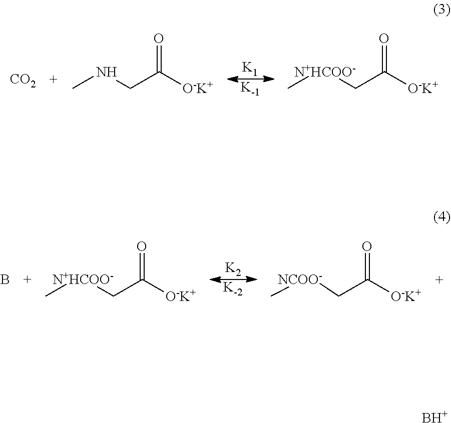

In addition to carbamates, CO₂ is also absorbed as bicarbonate species by various routes as shown in Reactions 5, 6 and 7. CO₂ absorption has been studied in K-Sar via NMR to reveal that carbamates are the primary species at low CO₂ loading while bicarbonates start forming at relatively high loading (Hartono et al., Energy Procedia, 4 (2011) 209-215). At the high CO₂ loading levels used in the current study, both carbamates and bicarbonates are present in K-Sar solvent.

KSarCOO⁻+H₂O→KSar+HCO₃⁻ (5)

CO₂+OH⁻→HCO₃⁻ (6)

CO₂+2 H₂O→HCO₃⁻+H₃O⁺ (7)

Since CO₂ is absorbed as carbamate and bicarbonate in K-Sar, regeneration of the solvent will involve breaking down these species to release CO₂. Just like its formation mechanism (Reactions 3 and 4), the decomposition of carbamates involves two steps: deprotonation of protonated K-Sar (Reaction 8) and carbamate breakdown (Reaction 9). The deprotonation reaction is energy intensive due to the barriers associated with transfer of a proton from KSarH⁺ in a highly alkaline solution to H₂O which is a relatively neutral molecule. It is worth mentioning that direct proton transfer from KSarH⁺ to carbamate is also a possibility if both ions are very close to each other. However, under all practical scenarios, both these ions are surrounded by water molecules which act as proton mediators between KSarH⁺ and carbamate. The heat of reaction for deprotonation and carbamate breakdown steps for MEA is known to be 73.4 kJ/mol and 15.47 kJ/mol, respectively, indicating the highly endothermic nature of these two reactions (H. Shi et al., International Journal of Greenhouse Gas Control, 26 (2014) 39-50). Since the carbamate breakdown reaction largely depends on the protons generated from the difficult to achieve Reaction 8, the entire process of solvent regeneration becomes energy intensive. As a result, a temperature greater than 100° C. is needed to regenerate CO₂-rich K-Sar.

KSarH⁺+H₂O→KSar+H₃O⁺ (8)

KSarCOO⁻+H₃O⁺→KSar+CO₂+H₂O (9)

It can be inferred from the above discussion that solvent regeneration becomes easier if the energy requirement for KSarH⁺ deprotonation can be decreased. The bicarbonate anion, HCO₃⁻, formed at high CO₂ loading is a stronger base than H₂O and therefore can carry out Reaction 8 in a more facile manner. Reaction 10 below shows the reaction between bicarbonate and KSarH+ which not only leads to deprotonation of the amine and transfer of the proton to carbamates, but also releases CO₂ via Reaction 11. This is one of the pathways for desorbing CO₂ from bicarbonate species formed during absorption runs. It has previously been shown that involvement of bicarbonates can reduce the heat of reaction for the deprotonation step to 21.2 kJ/mol (H. Shi et al., Ibid.).

KSarH⁺+HCO₃⁻+KSar+H₂CO₃ (10)

H₂CO₃—+CO₂+H₂O (11)

Referring back to FIGS. 4a-4b, the initial sharp increase in CO₂ evolution during the temperature ramp stage can be assigned to dissociation of bicarbonate species via Reactions 10 and 11 rather than carbamate decomposition. At these early regeneration times, the CO₂-rich solvent contains a significant amount of bicarbonate; however, as the temperature rises and the majority of bicarbonate is dissociated, carbamate remains as the major CO₂ containing species, making it more and more difficult to desorb CO₂. This is one of the primary reasons why the CO₂ desorption rate reaches a maximum value at 92° C. and then continues to decrease during the isothermal stage, as CO₂ evolution in this phase mainly occurs via carbamate decomposition. There are, of course, multiple other reasons that contributes to such a behavior. For instance, a significant amount of CO₂ is already desorbed during the temperature ramp stage, which continuously decreases the driving force for CO₂ desorption as the experiment is carried on. In addition, lower CO₂ and increasingly regenerated K-Sar concentrations in the solvent push the system closer to the CO₂ solubility equilibrium at the relevant regeneration temperature.

2. Regeneration Dynamics with Catalyst

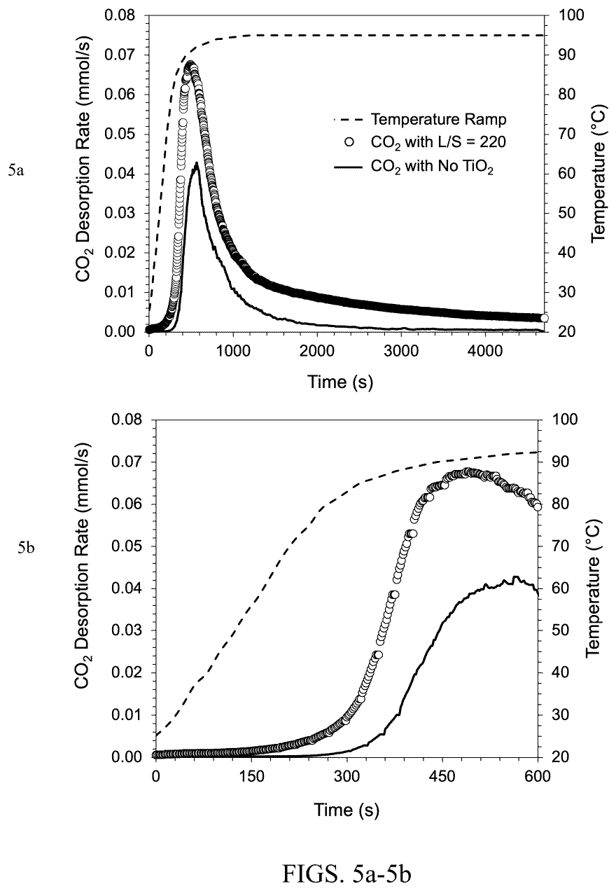

Now that the regeneration dynamics shown in FIGS. 4a-4b in the absence of a catalyst have been explained, the CO₂ desorption behavior in the presence of TiO₂ catalyst shown in FIGS. 5a and 5b can be discussed. FIG. 5a compares the CO₂ desorption rate during K-Sar regeneration in the absence of a catalyst (as also plotted in FIGS. 4a-4b) and in the presence of TiO₂ in a liquid to solid weight ratio (L/S) of 220. While FIG. 5a contains the entire experiment including temperature ramp and isothermal stages, FIG. 5b shows only the temperature ramp section for easier visualization. The positive impact of TiO₂ on K-Sar regeneration is easily seen in these figures. Compared to the no-catalyst case, an early onset of CO₂ evolution and a higher desorption rate are observed throughout the regeneration experiment in the presence of TiO₂. As shown in FIG. 5b, CO₂ release from the solvent in the presence of TiO₂ starts at 25° C., while this onset temperature is 70° C. when the catalyst is absent. A maximum CO₂ desorption rate of 0.068 mmol/sec is achieved with TiO₂, which is a 62% increase compared to the no-catalyst case.

An interesting observation from FIG. 5b is that this maximum desorption rate is achieved at an earlier time and a lower temperature for the case with TiO₂ compared to the no catalyst case. This behavior can be explained by the fact that the higher desorption rate with catalyst results in a much greater fraction of bicarbonates being dissociated compared to the no-catalyst case at a particular time. Hence, the relative amount of carbamate dominates bicarbonates at an earlier time when a catalyst is present, thereby shifting the maximum desorption rate to an earlier time and a lower temperature. Nevertheless, despite such a scenario, the CO₂ desorption rate in the presence of a catalyst continues to be higher than the desorption rate for the no catalyst case throughout the regeneration experiment. This behavior indicates that both bicarbonates and carbamates are more easily decomposed in the presence of TiO₂.

### 3. Possible Mechanisms of Catalytic Regeneration

The Bronsted and Lewis acid sites depicted in FIG. 2 facilitate the observed increase in CO₂ desorption in the presence of TiO₂ catalyst. The present results demonstrate the benefit of an acidic catalyst in amino acid-based solvent regeneration.

As discussed above, deprotonation of KSarH⁺ is the most energy intensive reaction in the entire solvent regeneration process. A Lewis acid site (LAS or L) present on the TiO₂ surface provides an easier and lower activation barrier pathway for this reaction. As shown in Reactions 12 and 13, LAS accepts a proton from KSarH⁺ and then transfers it to a water molecule to form H₃O⁺ ions. Note that LAS on metal oxide surfaces typically contains charge imbalanced metal ions (see FIG. 2), and their charge gives them the ability to accept a proton. The H₃O⁺ ions then react with either bicarbonate or carbamate species to release CO₂ via Reactions 14 and 15, respectively.

KSarH⁺+L→KSar+LH⁺ (12)

LH⁺+H₂O→L+H₃O⁺ (13)

LH⁺+HCO₃⁻→L+CO₂+H₂O (14)

KSarCOO⁻+H₃O⁺→KSar+CO₂+H₂O (15)

A Bronsted acid site (BAS or B) on the TiO₂ surface already contains a proton which allows a direct reaction with carbamate molecule and bicarbonate species, as depicted in Reactions 16 and 17. The BAS catalyzes these two reactions, regenerates itself by accepting protons from KSarH⁺ and thereby facilitates the energy intensive deprotonation reaction via Reaction 18.

KSarCOO⁻+BH⁺→KSarCOOH+B (16)

HOO₃⁻+BH+→B+CO₂+H₂O (17)

KSarH⁺+B→KSar+BH⁺ (18)

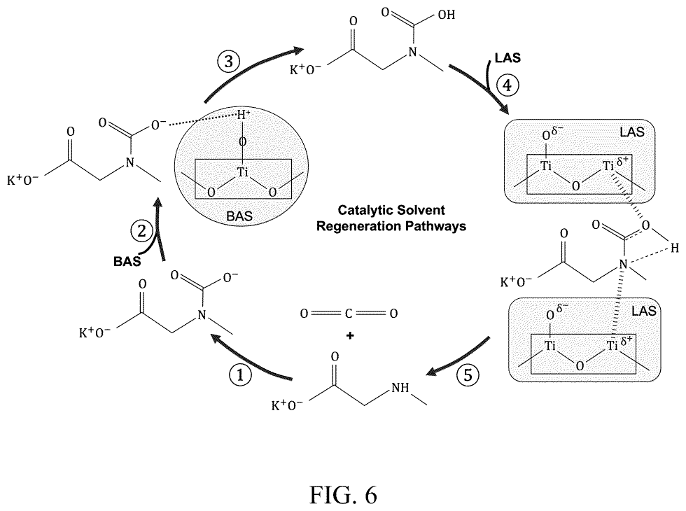

Presence of both Lewis and Bronsted acid sites is beneficial to catalytic solvent regeneration. Both of these sites can interact with either the O or N atoms in the carbamate molecule to ultimately weaken the N—C bond, thereby resulting in a lower energy barrier to bond breakage. FIG. 6 is a schematic showing how LAS and BAS are involved with the decomposition of carbamate species, KSarCOO⁻. During step 1 in FIG. 6, the carbamate species is formed due to reaction between K-Sar and CO₂. Decomposition of this molecule starts in step 2, where the oxygen anion (O⁻) in —COO⁻ group accepts the proton in BAS to form an acid in step 3 (also seen in Reaction 16). In step 4, the N atom in the amine group and O atom in-COOH group donate electrons to LAS. As a result, the N atom loses its lone pair of electrons, changes the configuration from sp2 to sp3 hybridization, stretches and weakens the N—C bond, delocalizes the N—COO⁻ conjunction, which ultimately breaks down the carbamate molecule with lower energy consumption and faster CO₂ desorption rate. A combination of Lewis and Bronsted acid sites thus facilitates the decomposition of a carbamate molecule. As a consequence, the relative densities of these two acidic sites can affect the performance of a catalyst. In fact, an optimum ratio of LAS and BAS may provide the maximum increase in CO₂ regeneration rate.

### 4. Optimal Solvent to Catalyst Ratio

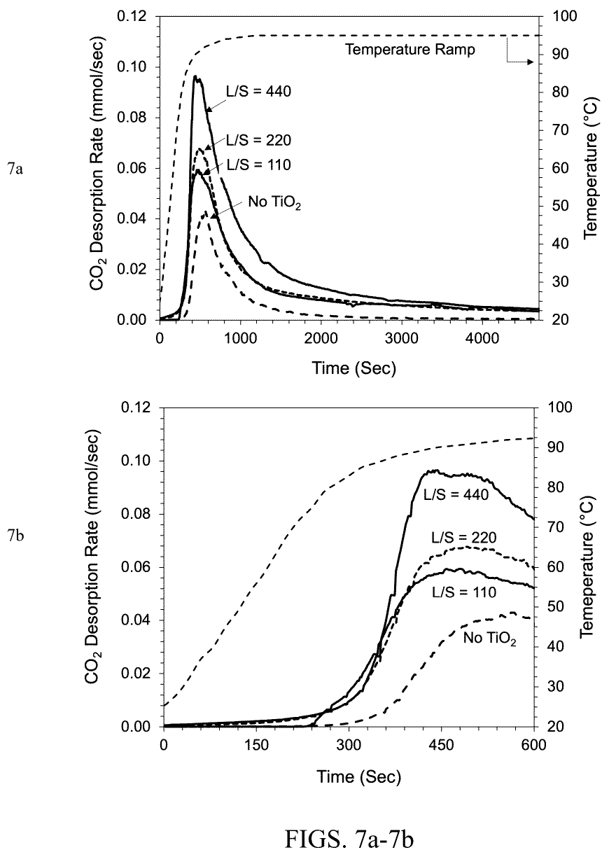

The discussion thus far has been focused on the benefit of TiO₂ in K-Sar regeneration and the proposed reaction pathways and mechanisms behind these observations. Subsequent experiments were directed to catalyst weight optimization for maximum benefit on solvent regeneration. FIGS. 7a and 7b show the CO₂ desorption rates during K-Sar regeneration in the absence of a catalyst and the presence of various amounts of TiO₂ catalyst, with liquid to solid ratios (L/S) of 110, 220 and 440. All the experiments with TiO₂ showed substantially higher CO₂ desorption compared to the no-catalyst case. The highest CO₂ desorption rate of 0.096 mmol/see was observed with L/S=440, which is a 128% improvement over the no-catalyst case. The desorption rate decreased with further increase in catalyst weight (i.e., with decrease in L/S). Consequently, an optimum L/S ratio exists for maximum improvement in K-Sar regeneration. A larger amount of catalyst does not necessarily lead to a higher CO₂ desorption.

FIG. 7b further shows that although the cumulative amount of CO₂ desorption varies with L/S ratio, the CO₂ release onset temperature is similar for all experiments with catalyst. In fact, the CO₂ desorption profile is very similar during the temperature ramp stage. Only when the experiment approaches the isothermal stage, the desorption rates start deviating from one another. It was mentioned earlier that the initial sharp rise in CO₂ desorption may be assigned to bicarbonate species dissociation, while the contribution from carbamate decomposition starts at a later time and higher temperature. Since the impact of L/S ratio is mostly visible at higher temperatures, this seems to indicate that carbamate decomposition is preferentially slowed down with an increase in catalyst amount beyond the optimum value.

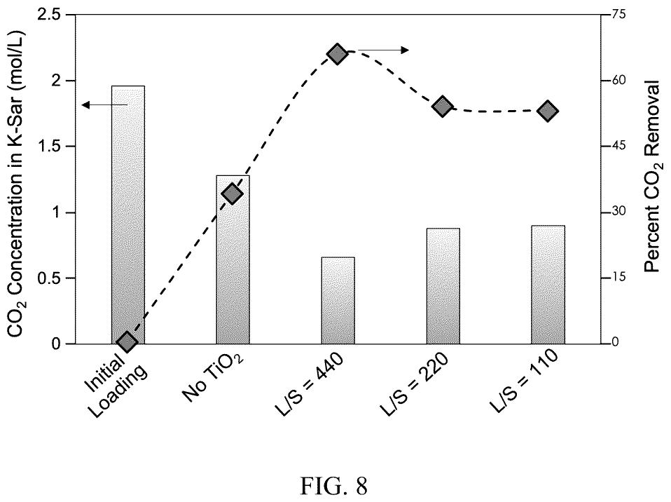

The CO₂ desorption curves shown in FIGS. 4a-4b, 5a-5b and 7a-7b were all collected by measuring the gas phase CO₂ concentration in exhaust gas. The CO₂ content in K-Sar solvent was also measured using total inorganic carbon analysis that provides an accurate estimation of CO₂ in the solvent before and after regeneration. The concentration data are plotted in FIG. 8. The bars in the figure indicate CO₂ concentration in solvent, while the diamond symbols indicate percentage of CO₂ removed from the initial CO₂-loaded solvent. The initial CO₂-loading in the K-Sar solvent following CO₂ absorption was measured to be 1.96 mol/L. Upon regeneration of this solvent at 95° C. (includes ramp and the isothermal hold for 90 mins) in the absence of any catalyst, 1.28 mol/L of CO₂ remained, indicating a 35% removal of absorbed CO₂. When TiO₂ with L/S=440 was used, 0.66 mol/L of CO₂ remained in the solvent, thereby achieving a 67% removal of absorbed CO₂, which is more than 90% increase over the no catalyst case. As the catalyst weight was increased (or L/S is lowered), the CO₂ content of the regenerated solvent increased and, therefore, the CO₂ removal efficiency decreased. Such observations from the solvent's CO₂ content measurement agree well with the trend seen from exhaust gas measurement shown in FIGS. 7a-7b. Both gas phase and liquid phase CO₂ measurements establish L/S=440 as the optimum scenario among the experiments performed in this study. Notably, in previous work studying the impact of ZnO and ZrO₂ catalyst weight on regeneration of CO₂-rich MEA solvent, it was found that the CO₂ desorption rate increases monotonically with catalyst weight increase (U. H. Batti et al., ACS Sustainable Chemistry & Engineering, 5, 2017 5862-5868). However, this diverges from the present observation for the TiO₂ catalyst in K-Sar regeneration. As discussed below, TiO₂ can also enhance the rate of CO₂ absorption in K-Sar, which is a possible explanation of why an optimum catalyst weight exits in the present case.

### 5. Influence of Catalyst on CO₂ Absorption

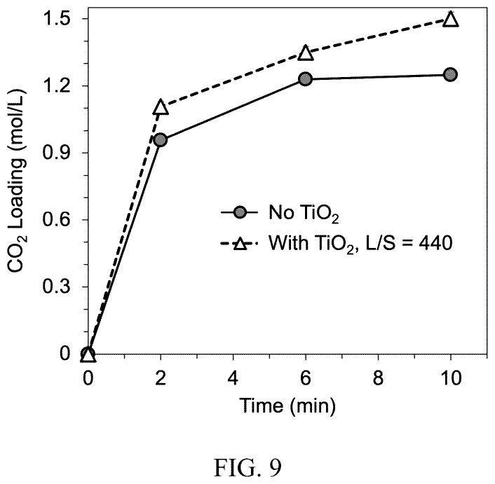

Absorption of CO₂ in K-Sar was carried out at room temperature in the presence and absence of TiO₂. Solvent samples were collected at various time intervals to measure the absorbed CO₂ content. FIG. 9 shows CO₂ loading in K-Sar solvent in the absence of a catalyst and the presence of TiO₂ (L/S=220) as a function of absorption time. A substantial increase in CO₂ absorption rate as well as cumulative absorption was observed for the case with TiO₂. After 10 mins of CO₂ absorption, the no-catalyst case showed 1.25 mol/L CO₂ loading while a loading of 1.5 mol/L was achieved in the presence of TiO₂ (20% increase). This clearly shows that TiO₂ not only improves the regeneration kinetics of CO₂-rich K-Sar, but also facilitates better CO₂ absorption. Multiple pathways are known for a catalyst to improve a solvent's CO₂ absorption ability, such as: (a) unsaturated transition metal ions can interact with CO₂, increasing the carbon atom's charge, thereby accelerating the electrophilic addition to form zwitterion with the amine; (b) oxygen vacancies on metal oxides could weakly bind CO₂ thus facilitating reaction with amine; (c) larger solid surface area increases mass and heat transfer.

### 6. Energy Savings Through Catalytic Regeneration

The dual functionality of TiO₂ which allows it to accelerate both absorption and desorption rates can potentially lead to the observed optimum L/S ratio in FIGS. 7 and 8. During regeneration tests, the re-absorption of CO₂ is minimal until a substantial fraction of the absorbed CO₂ leaves the solvent due to a low chemical driving force and concentration gradient. As a result, all desorption profiles look similar during the initial ˜200 seconds in FIG. 7 irrespective of the catalyst weight. However, as the CO₂ content in the solvent continues to decrease, the chemical driving force for CO₂ re-absorption increases. Note that although the CO₂ content in the solvent is low, the temperature is still high (>90° C.) and therefore the CO₂ re-absorption rates are not as high as the room temperature kinetics seen in FIG. 8. However, as the catalyst amount increases beyond the optimum L/S of 440, the re-adsorption phenomenon has enough contribution to gradually decrease the effective CO₂ desorption rates. It can also be surmised that such re-absorption not only results in the observed optimum L/S ratio, but also contributes to the diminishing CO₂ desorption rate as a function of time during isothermal regeneration phase for each L/S.

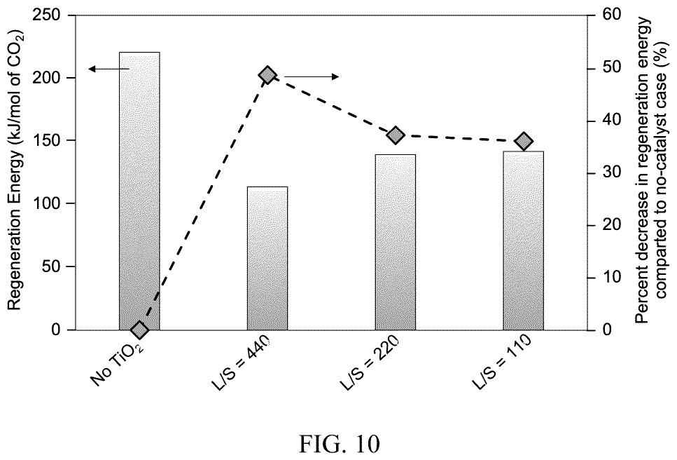

The energy required for CO₂-rich K-Sar regeneration was calculated based on the electrical energy input to the solvent heating system. The total energy spent was then normalized over per mol of CO₂ released for each experimental case and plotted in FIG. 10. The bars represent solvent regeneration energy while the diamond symbols represent the reduction in regeneration energy achieved for each L/S ratio compared to the no catalyst case. K-Sar regeneration energy without any catalyst was found to be 234 kJ/mol of CO₂ released. It is worth mentioning that these values overestimate the actual regeneration energy values since the solvent vessel is not insulated and hence part of the supplied electrical energy is lost into the surrounding environment. A combined TGA-DSC-FTIR technique was previously used to measure the regeneration energy of CO₂-loaded 3M K-Sar and reported the value as 161 kJ/mol (Kasturi et al., Ibid.). Although the value currently obtained is slightly higher due to the unaccounted heat loss from the system, it still provides a close practical approximation.

Assuming similar heat loss from all regeneration tests performed in this study, the regeneration energies calculated in the presence of catalyst can now be compared to the no-catalyst case. In the presence of TiO₂ at L/S=440, the regeneration energy is calculated to be 113 kJ/mol which a 49% reduction compared to the no-catalyst case. When the catalyst amount is increased (L/S=110 and 220), the regeneration energy increases, but still provides more than 35% reduction compared to the no catalyst case. Table 1 (below) shows a comparison of energy savings from various catalytic regeneration studies reported in the literature. As already noted, the present work reports a catalytic regeneration effect on an amino acid-based solvent. A substantial reduction in regeneration energy is obtained for K-Sar with TiO₂ addition compared to the other listed solvent-catalyst combinations, which indicates that amino acid-based solvents can be good candidates for catalytic regeneration. Overall, this work demonstrates that catalyst-assisted solvent regeneration can provide substantial solvent regeneration energy savings, thereby making the entire CO₂ capture process more energy efficient.

TABLE 1
Comparison of various solvent catalytic regeneration studies in
the literature that provided information on regeneration energy

| | | | Regeneration | % Reduction in |
|---|---|---|---|---|
| | | | Temperature | Regeneration |
| Reference | Solvent | Catalyst | (° C.) | Energy |
| Bariq et al. ¹ | 5M MEA | CMK-3-SiO₂ | 97 | 37% |
| Bhatti et al. ² | 5M MEA | Montmorillonite- | 85 | 45% |
| | | SO₄⁻ | | |
| Zhang et al. ³ | 5M MEA | SAPO-34 | 96 | 24% |
| Zhang et al. ⁴ | 3M MEA + 2.5M | H-ZSM-5 | 96 | 20% |
| | AMP + 0.5M PZ | | | |
| Liu et al. ⁵ | 5M MEA + 1M | H-ZSM-5 | 98 | 27% |
| | 1DMA2P | | | |
| Liu et al. | 5M MEA + 1M | MCM-41 | 98 | 17% |
| | DEEA | | | |
| Srisang et al. ⁶ | 5M MEA | γ-Al₂O₃ | 85 | 10% |
| Zhang et al. ⁷ | 5M MEA | Fe-MCM-41 | 98 | 33% |
| This work | 3M K-Sar | TiO₂ | 95 | 49% |

References for Table 1:
¹ Z. A. S. Bairq, H. Gao, F. A. M. Murshed, P. Tontiwachwuthikul, Z. Liang, Modified Heterogeneous Catalyst-Aided Regeneration of CO2 Capture Amines: A Promising Perspective for a Drastic Reduction in Energy Consumption, ACS Sustainable Chemistry & Engineering, 8 (2020) 9526-9536
² U. H. Bhatti, H. Sultan, G. H. Min, S. C. Nam, I. H. Baek, Ion-exchanged montmorillonite as simple and effective catalysts for efficient CO2 capture, Chemical Engineering Journal, 413 (2021).
³ X. Zhang, X. Zhang, H. Liu, W. Li, M. Xiao, H. Gao, Z. Liang, Reduction of energy requirement of CO2 desorption from a rich CO2 -loaded MEA solution by using solid acid catalysts, Applied Energy, 202 (2017) 673-684.
⁴ X. Zhang, R. Zhang, H. Liu, H. Gao, Z. Liang, Evaluating CO2 desorption performance in CO2 -loaded aqueous tri-solvent blend amines with and without solid acid catalysts, Applied Energy, 218 (2018) 417-429.
⁵ H. Liu, X. Zhang, H. Gao, Z. Liang, R. Idem, P. Tontiwachwuthikul, Investigation of CO2 Regeneration in Single and Blended Amine Solvents with and without Catalyst, Industrial & Engineering Chemistry Research, 56 (2017) 7656-7664.
⁶ W. Srisang, F. Pouryousefi, P. A. Osei, B. Decardi-Nelson, A. Akachuku, P. Tontiwachwuthikul, R. Idem, Evaluation of the heat duty of catalyst-aided amine-based post combustion CO2 capture, Chemical Engineering Science, 170 (2017) 48-57.
⁷ X. Zhang, Y. Huang, J. Yang, H. Gao, Y. Huang, X. Luo, Z. Liang, P. Tontiwachwuthikul, Amine-based CO2 capture aided by acid-basic bifunctional catalyst: Advancement of amine regeneration using metal modified MCM-41, Chemical Engineering Journal, 383 (2020).

### 7. Effect of Temperature on Solvent Regeneration

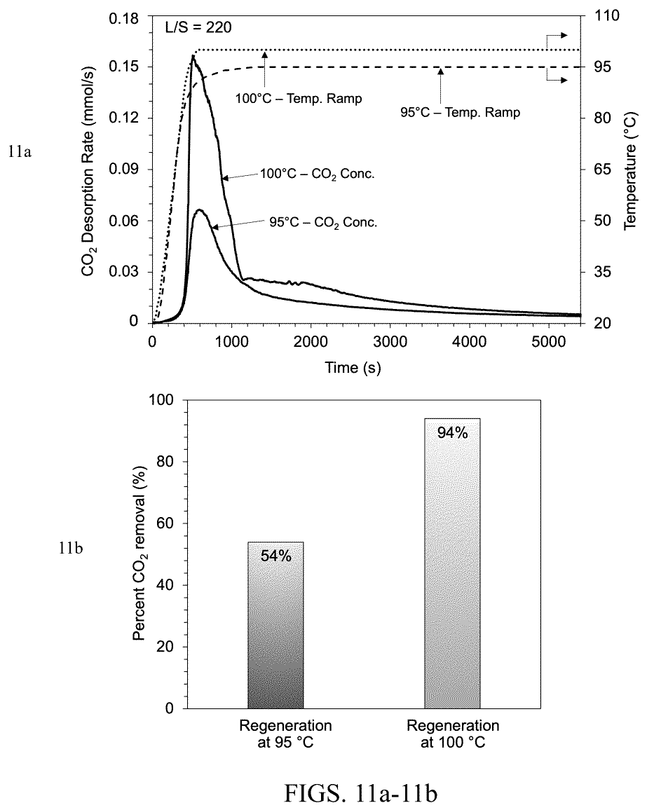

Effect of temperature on K-Sar regeneration was investigated by heating the solvent in the presence of TiO₂ (L/S=220) up to two different temperatures: 95° C. and 100° C. Results obtained at 95° C. have already been shown in FIGS. 5 and 7 and discussed in detail. As seen in FIG. 11a, a much larger amount of CO₂ was desorbed when the regeneration was performed at 100° C. compared to that at 95° C. This behavior was predicted based on the idea that more bicarbonate and carbamate molecules decompose at higher solvent temperatures due to the endothermic nature of these reactions. FIG. 11b shows the percent removal of absorbed CO₂ during regeneration at 95° C. and 100° C. As evident from the FIG. 11b, 94% of total absorbed CO₂ was released at 100° C. compared to only 54% at 95° C. Therefore, by increasing the temperature by just 5° C., near complete regeneration of K-Sar solvent in the presence of TiO₂ can be achieved. Note that K-Sar regeneration typically needs 110° C.-120° C.; therefore, the catalyst-assisted regeneration strategy can provide energy savings in two different ways: (a) by increasing CO₂ desorption kinetics at a fixed temperature, and (b) by decreasing the regeneration temperature. Since the normal boiling point of water is 100° C., any temperature above this value will lead to a much higher heat requirement due to vaporization of water.

### 8. Effect of Temperature on Catalyst Stability

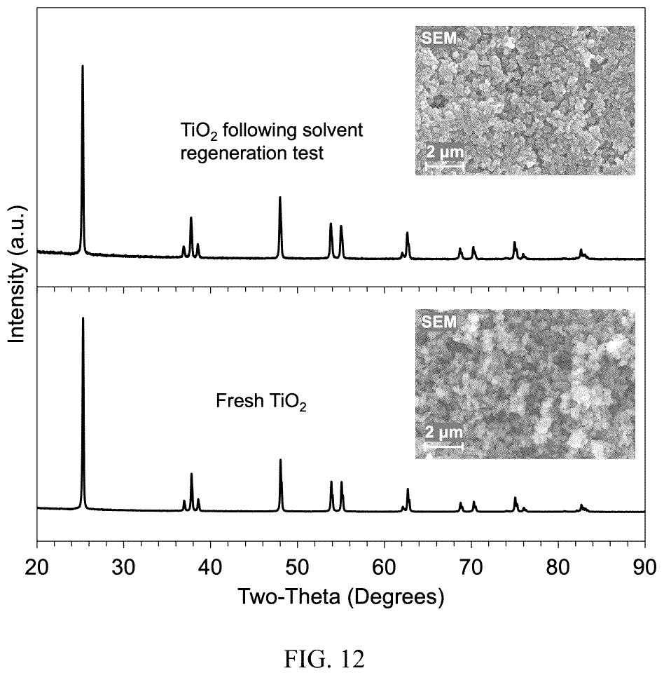

The stability of TiO₂ in the harsh alkaline K-Sar regeneration environment was investigated by collecting its X-ray diffraction pattern before and after being utilized in K-Sar regeneration at 100° C. As seen in FIG. 12, both these diffractograms are practically identical, and all diffraction peaks suggest the anatase crystalline form of TiO₂ (e.g., A. Orendorz et al., Surface Science, 601 (2007) 4390-4394; and K. Thamaphat et al., Agriculture and Natural Resources, 42 (2008) 357-361. Absence of any additional peaks indicates that no impurity phases were formed during solvent regeneration. Moreover, the respective SEM images shown in the two insets in FIG. 12 also show no visible change in particle size and morphology. Energy dispersive X-ray spectra were also collected during SEM imaging. These spectra complement XRD data showing no visible segregation of titanium or oxygen on the post-regeneration sample. Therefore, TiO₂ is a stable catalyst for K-Sar solvent regeneration application.

### 9. Effect of Temperature on Solvent Stability

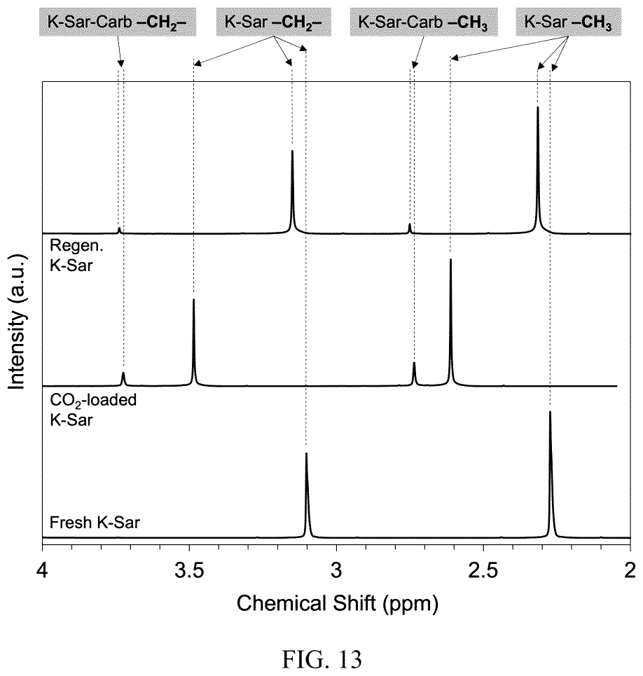

Finally, stability of the K-Sar solvent upon interaction with TiO₂ was also ascertained by collecting NMR spectra in its fresh, CO₂-loaded and catalytically regenerated conditions. FIG. 13 shows the ¹H NMR spectra in the fingerprint region (2-4 ppm) of K-Sar. FIG. 13 shows two main peaks for Fresh K-Sar; the peak at 2.27 ppm chemical shift comes from the —CH₃ group in K-Sar, while the peak at 3.10 ppm arises due to the —CH₂ group (A. Hartono et al., Ibid.). For the CO₂-loaded solvent, these two peaks shift to lower field due to an increase in protonated amine, since the resulting ammonium group has a strong electron withdrawing capacity that inductively withdraws electrons from the —CH₃ and —CH₂ groups (G.-J. Fan et al., Industrial & Engineering Chemistry Research, 48 (2009) 2717-2720). Consequently, the —CH₃ peak shifts to 2.61 ppm while the —CH₂ peak shifts to 3.48 ppm. The CO₂-loaded sample also manifests two more peaks due to carbamate formation; the one at 1.86 ppm can be assigned to —CH₃ group, while the one at 1.28 ppm belongs to —CH₂ group in carbamate (A. Hartono et al., Ibid.). The positioning of these two carbamate peaks is on the downfield side compared to the corresponding peaks from fresh K-Sar; this is due to the strong electron withdrawing nature of the carbonyl group in carbamate (G.-J. Fan et al., Ibid.). The intensity of both these peaks decrease significantly in the spectra collected from regenerated K-Sar due to loss of CO₂. The peaks belonging to —CH₃ and —CH₂ groups in K-Sar also gradually shift to their original positions observed under a fresh solvent condition. Most importantly, no additional impurity peaks were noticeable in the regenerated solvent NMR spectra, which indicates no degradation of the solvent during regeneration. Hence, the XRD and NMR characterization results indicate that the catalytic regeneration system is overall a robust system where neither the catalyst nor the solvent experiences any severe degradation, which would otherwise lead to performance deterioration.

The TiO₂ catalyst used in this study is a simple transition metal oxide containing sufficient hydrothermal stability and acidic site density that achieves improved K-Sar regeneration. It is worth mentioning that the performance reported in this paper is just a baseline, and better results may be obtained when TiO₂ is modified with additional hetero phases, such as SiO₂ or Al₂O₃, to attain better hydrothermal stability and higher acidic site density. Moreover, other highly dispersed active metal sites can be deposited on TiO₂ to improve its catalytic activity.

### CONCLUSIONS

The present work investigated the impact of TiO₂ solid acid catalyst on the regeneration behavior of CO₂-loaded K-Sar solvent. The presence of TiO₂ catalyst improved the CO₂ desorption rate from K-Sar by 128% and the total CO₂ desorption by 90% when compared to the case without any catalyst. Such improvement in solvent regeneration kinetics is a result of the Lewis and Bronsted acid sites present on the surface of TiO₂. These acid sites can facilitate key reaction steps such as deprotonation of protonated K-Sar, decomposition of carbamates and bicarbonates that ultimately leads to the release of captured CO₂, and regeneration of the solvent prior to its reuse. The total regeneration energy was reduced by about 50% via catalytic regeneration. The overall energy efficiency of the CO₂ capture process can thus be significantly enhanced by solvent catalytic regeneration. Additional characterization results demonstrated that both the catalyst and solvent are physically and chemically stable under the operating environment. Significant energy savings, long-term stability and straightforward adaptability in existing regeneration units make the concept of catalytic solvent regeneration a promising approach for reducing the energy penalty of CO₂ capture.

While there have been shown and described what are at present considered the preferred embodiments of the invention, those skilled in the art may make various changes and modifications which remain within the scope of the invention defined by the appended claims.

What is claimed is:

1. A method for regenerating an amine-containing sorbent useful in the capture of carbon dioxide (CO₂), the method comprising contacting a CO₂ complex of the amine-containing sorbent in solution with a metal oxide material while the solution is at a temperature within a range of 60-130° C. to result in release of CO₂ and regeneration of the amine-containing sorbent, wherein the CO₂ in the CO₂ complex is in the form of a carbamate or bicarbonate moiety attached to the amine-containing sorbent, and wherein said metal oxide material is a transition metal oxide or main group metal oxide material.

2. The method of claim 1, wherein the amine-containing sorbent is an amino acid, wherein the amino acid is in uncharged form, zwitterionic form, or deprotonated anionic salt form.

3. The method of claim 2, wherein the amino acid is sarcosine, wherein the sarcosine is in uncharged form, zwitterionic form, or deprotonated anionic salt form (sarcosinate).

4. The method of claim 1, wherein the amine-containing sorbent is an alkylamine.

5. The method of claim 1, wherein the amine-containing sorbent is an alkanolamine.

6. The method of claim 5, wherein the alkanolamine is selected from the group consisting of monoethanolamine (MEA), diethanolamine (DEA), triethanolamine (TEA), and methyldiethanolamine (MDEA).

7. The method of claim 5, wherein the alkanolamine is selected from amine biphasic solvents.

8. The method of claim 1, wherein the metal oxide comprises a transition metal oxide.

9. The method of claim 8, wherein the transition metal oxide is selected from the group consisting of TiO₂, TiO(OH)₂, MoO₃, V₂O₅, Cr₂O₃, WO₃, Ag₂O, Nb₂O₅, NiO, CuO, MnO₂, ZrO₂, Fe₂O₃, Fe₃O₄, ZnO, and combinations thereof.

10. The method of claim 8, wherein the transition metal oxide comprises TiO₂ or TiO(OH)₂.

11. The method of claim 1, wherein the metal oxide comprises a main group metal oxide.

12. The method of claim 11, wherein the main group metal oxide comprises Al₂O₃.

13. The method of claim 11, wherein the main group metal oxide comprises an aluminosilicate.

14. The method of claim 1, wherein the metal oxide material is in particulate form.

15. The method of claim 14, wherein the metal oxide has a particle size of 1-1000 nm.

16. The method of claim 1, wherein the metal oxide material is in pellet form, wherein the pellets have a size of at least 1 mm.

17. The method of claim 1, wherein the metal oxide material has a monolithic structure constructed of bonded particles and channels for heating or cooling liquid flow between the channels, wherein at least the surface of the particles in the monolithic structure have a metal oxide composition selected from transition metal and main group metal oxide compositions.

18. The method of claim 17, wherein the metal oxide comprises a transition metal oxide.

19. The method of claim 18, wherein the transition metal oxide is selected from the group consisting of TiO₂, TiO(OH)₂, MoO₃, V₂O₅, Cr₂O₃, WO₃, Ag₂O, Nb₂O₅, NiO, CuO, MnO₂, ZrO₂, Fe₂O₃, Fe₃O₄, ZnO, and combinations thereof.

20. The method of claim 18, wherein the transition metal oxide is TiO₂ or TiO(OH)₂.

21. The method of claim 1, wherein the regenerated amine-containing sorbent is re-used to capture CO₂ and form a complex therewith.

22. The method of claim 1, wherein the method for regenerating the amine-containing sorbent is integrated with a CO₂ capture process.

23. The method of claim 1, wherein the released CO₂ is quarantined for storage or use.
